(19) United States
(12) Patent Application Publication
(10) Pub. No.: US 2002/0027597 A1
(43) Pub. Date: Mar. 7, 2002

(54) System for mobile videoconferencing

(76) Inventor: John Sachau, Colts Neck, NJ (US)

Correspondence Address: Jean-Marc Zimmerman, 226 St. Paul Street, Westfield, NJ, 07090, US

(21) Appl. No.: 09/946,387

(22) Filed: Sep. 5, 2001

Related U.S. Application Data
(60) Provisional application No. 60/230,125, filed on Sep. 5, 2000.

(51) Int. Cl. H04N 7/14

(52) U.S. Cl. 348/14.1

(57) ABSTRACT

A system for videoconferencing having mobile capabilities, wherein at least one end of a communications link between two locations employs a wireless and/or fiber optically coupled transmitter/receiver pair or transceivers. The system enables a host at one end of the link to physically move around the location at which they are located, thereby enabling an audience at the other end of the link to be taken on a moving tour of the host's location and view changing scenes rather than viewing an image recorded from a stationary position at the second location as is the case when using conventional videoconferencing systems.

### PRIORITY NOTICE

This Non-Provisional U.S. Patent Application claims the benefit of the Sep. 5, 2000 filing date of Provisional U.S. patent application Ser. No. 60/230,125.

### FIELD OF THE INVENTION

The present invention pertains to the field of teleconferencing, and more particularly to a videoconferencing system having mobile capabilities.

### BACKGROUND OF THE INVENTION

Teleconferencing has been used for more than thirty years by businesses, governments, educational institutions and other entities to enable parties in different geographic locations to communicate with one another. Teleconferencing eliminates the need for a first party to have to travel to a distant location to communicate in person with a second party, thereby saving the first party the time and expense associated with such travel. It also saves the second party the time and expense associated with having to entertain and/or host the first party.

Conventional teleconferencing systems typically operate by establishing a communications link over a telephone line between two different locations. Videoconferencing is a type of teleconferencing that allows parties at the two locations to speak to and to see one another. At each one of these locations, a camera, a monitor, a microphone, and a speaker are coupled to a device that interfaces with the telephone lines, wherein the camera and the microphone are used to record the images and sounds that are to be transmitted to the other location, and the monitor and speaker are used to broadcast the images and sounds recorded at the other location.

Conventional teleconferencing systems provide point-to-point communications. Specifically, such systems provide parties with the ability to communicate between at least two fixed locations such as a conference room, meeting room, etc. Conventional teleconferencing systems suffer from several drawbacks. First, the production quality of such communications is typically poor. Second, such communications typically occur at speeds no greater than 384 Kbps. Finally, and most limiting, such systems have no mobility, such that the parties at one end of a communications link between two locations are only able to view what a stationary camera at the other end of the link records. The present invention overcomes the foregoing drawbacks by providing a teleconferencing system that employs wireless and/or fiber optic components to provide mobile capabilities and much improved production standards to such systems so that teleconferencing can be used in ways that were heretofore impossible.

### SUMMARY OF THE INVENTION

A system for videoconferencing having mobile capabilities, wherein at least one end of a two-end communications link employs a wireless and/or fiber optically coupled transmitter/receiver pair or transceivers. The system provides mobility to at least one party at one end of the link, i.e., the first location, thereby enabling such party to physically move around the first location and enabling a party at the other end of the link, i.e., the second location, to be taken on a moving tour of and view changing scenes from the first location rather than viewing an image of said location recorded from a stationary position as is provided by conventional videoconferencing systems. In an alternative embodiment of the present invention, both ends of the communications link have mobile capabilities.

### BRIEF DESCRIPTION OF THE DRAWINGS

FIG. 1 shows a block diagram of a first exemplary embodiment of a teleconferencing system having mobile capabilities according to the present invention.

### DETAILED DESCRIPTION OF THE INVENTION

The present invention discloses a teleconferencing system 10 having mobile capabilities so that a conferee, i.e., an audience, at a first location can be taken on a walking or otherwise moving tour by a conferee, i.e., host, at a second location. At the first location, the components employed are the same ones employed at one end of a conventional videoconferencing system link. Specifically, a monitor and a speaker are used to enable the audience to see and hear, respectively, communications from the host at the second location. In addition, a camera and a microphone at the first location enable the host at the second location to see and hear the audience. The monitor, speaker, camera and microphone are all coupled to a compression/decompression (CODEC) device that serves as the interface to and from the ISDN (integrated service digital network) lines over which communications with the second location occur.

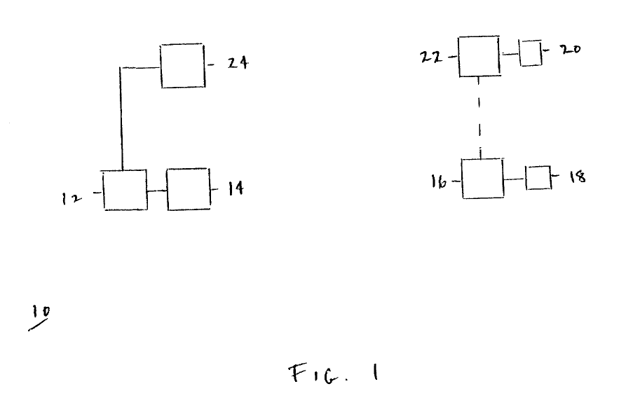

FIG. 1 shows the components of system 10 that are employed at the second location. A second CODEC 12 outputs video and audio signals received over the ISDN lines from the first location to a transmitter 14 which transmits such signals to a remote receiver 16 located elsewhere on the premises of the second location. Remote receiver 16 is coupled to a video and audio monitor 18 that enables the host to view and hear the audience at the first location.

A remote camera 20 records the host and is coupled to a remote transmitter 22 that transmits the recorded video and audio signals, e.g., of the host at the second location, to a receiver 24. The video and audio are input by receiver 24 to CODEC 12 which transmits the signals over the ISDN lines to the audience at the first location, thereby enabling the audience to see and hear the host at the second location.

Like conventional videoconferencing systems, system 10 enables the audience and the host both to see one another and to converse with one another. However, unlike conventional systems, system 10 enables the host to move freely around the second location. This mobility enables the host to take the audience at the first location on a moving tour of the second location. Thus, the audience can ask the host to stop and examine things that the audience sees that are of interest to them, and/or they can ask questions of persons that the host encounters while touring the second location. By employing this mobility, the present invention uses CODECs in ways such hardware was never originally intended to be used.

The mobility of system 10 results from transmitters 14 and 22 and receivers 16 and 24 being implemented either as wireless components or as components that are coupled to one another using lightweight, fiber optic cable. Alternatively, transmitters 14 and 22 and receivers 16 and 24 could be implemented using a combination of wireless and fiber optically coupled components. The transmitter/receiver pairs 14 and 16, and 22 and 24 provide full duplex video and audio communications between the first and second locations. These components enable videoconferencing to be used in ways never before done.

For example, system 10 can enable the audience at the first location to be taken on a tour of a vineyard at the second location, wherein the host is a vineyard employee who strolls the vineyard grounds using camera 20 to show the audience the vineyard while answering any questions the audience may have. The audience at the first location can be situated in any meeting place, such as a hotel ballroom, a school auditorium, a lecture hall, a movie theater, a tent, a restaurant, a department store, etc. The use of wireless and/or optically coupled components results in improved production quality compared to conventional videoconferencing systems. Moreover, using such components and the first and second CODECs together with multiple ISDN lines enables videoconferencing to occur at speeds greater than 384 Kbps.

System 10 can also be used for numerous other purposes. For example, system 10 can be used by a museum to provide the audience with a tour of different salons and exhibits in a museum, or it can be used by a travel agent to provide the audience with a tour of the different accommodations and activities of a resort, or it can be used by a university to provide the audience with a tour of the university. Thus, the locales where system 10 can be used are limitless. It is understood that the audience at the first location can be comprised of any number of persons, and that multiple hosts at the second location can be involved in a videoconference. In addition, more than two locations can be simultaneously included in a videoconference using the present invention. Also, the mobility provided by system 10 enables the host to walk, ride a bicycle, drive a vehicle, or otherwise move while taking the audience on a moving tour of the second location.

In an alternative embodiment of the present invention, two transceivers are used in place of transmitter/receiver pairs 14 and 16, and 22 and 24. In another alternative embodiment of the present invention, the components shown in FIG. 1 are used at both the first and second locations so that system 10 has mobile capabilities at both ends of the communications link. In still another alternative embodiment of the present invention, codec 12 is implemented as a portable device that eliminates the need to use one of the transmitter/receiver pairs or one of the transceivers.

Although communications using system 10 will typically occur at present over ISDN lines, such communications can occur over other communications links, such as microwave, satellite systems, high speed land lines or standard telephone wire. The present invention can also be used to deliver videoconferencing over the Internet.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications are reserved.

What is claimed is:

1. A system for videoconferencing, comprising:
a first means for at least one person at a first location to participate in a video conference; and
a second means for at least one person at a second location to participate in a video conference, wherein the second means includes a mobility capability so that the at least one person at the first location can be mobile while participating in the video conference.

2. The system according to claim 1, wherein the first means also includes a mobility capability so that the at least one person at the second location can be mobile while participating in the video conference.

3. The system according to claim 1, wherein the first means employs a monitor, a speaker, a camera and a microphone that are all coupled to a CODEC that serves as an interface to and from an ISDN line over which audio and video communications with the second location occur.

4. The system according to claim 3 further comprising a second CODEC that outputs communications received over the ISDN line from the first location to a first transmitter that transmits said communications to a first receiver coupled to a monitor that enables the at least one person at the second location to view and hear the at least one person at the first location.

5. The system according to claim 4, further including a camera and a second transmitter coupled to one another that transmit recorded audio and video signals of the at least one person at the second location to a second receiver that inputs said signals to the second CODEC for transmission over the ISDN line to the at least one person at the first location, thereby enabling the at least one person at the first location to hear and see the at least one person at the second location.

6. The system according to claim 1, wherein the system enables the at least one person at the second location to move freely around the second location thereby enabling the at least one person at the first location to be taken on a moving tour of the second location.

7. The system according to claim 6, wherein the at least one person at the first location can ask the at least one person at the second location to stop and examine an object of interest that the at least person at the first location views, and the at least one person at the first location can ask questions of another person that the at least second person encounters while touring the second location.

8. The system according to claim 5, wherein the first transmitter and first receiver, and the second transmitter and the second receiver are implemented as wireless components.

9. The system according to claim 5, wherein first transmitter and the first receiver, and the second transmitter and the second receiver are coupled to one another using lightweight, fiber-optic cable.

10. The system according to claim 5, wherein at least one of the first and second transmitter and receiver pairs are implemented using a combination of wireless and fiber-optically coupled components.

11. A system for mobile videoconferencing comprising:
a first videoconferencing means situated at a first location; and
a second videoconferencing means situated at a second location, wherein communications between the first and second videoconferencing means occur over a communications link, and wherein the second videoconferencing means includes components that provide a mobility capability so that a person at the second location can move freely around the second location thereby enabling a person at the first location to be taken on a moving tour of the second location.

12. The system according to claim 17, wherein the mobility capability is provided by components including a first transmitter that transmits communications received from the first location to a first receiver coupled to a monitor that enables at least one person at the second location to view and hear a person at the first location, and further including a second transmitter that transmits recorded audio and video signals of the at least one person at the second location to a second receiver for transmission over the communicating link to the first location, thereby enabling the person at the first location to hear and see the at least one person at the second location.

13. The system according to claim 11, wherein the system provides full duplex video and audio communications between the first and second locations.

14. The system according to claim 11, wherein communications occur between the first location and second location over the Internet.

15. The system according to claim 11, wherein communications occur between the first location and second location over a satellite system.

16. The system according to claim 11, wherein communications occur between the first location and second location over a high speed land line.

17. The system according to claim 11, wherein communications occur between the first location and second location over a telephone line.

18. The system according to claim 11, wherein communications occur between the first location and second location over a microwave system.

19. The system according to claim 11, wherein the mobility capability is provided by wireless components.

20. The system according to claim 11, wherein the mobility capability is provided by fiber-optically coupled components.

21. A method for mobile videoconferencing, comprising the steps of:
providing videoconferencing means at a first location to and from which videoconferencing communications, occur, wherein the means enables at least one person at the first location to move freely around the first location thereby enabling a person at a second videoconferencing location to be taken on a moving tour of the first location.

22. The system according to claim 19, wherein the method is implemented using wireless components.

23. The system according to claim 19, wherein the method is implemented using fiber-optically coupled components.
